(19) United States
(12) Patent Application Publication
(10) Pub. No.: US 2026/0228929 A1
(43) Pub. Date: Aug. 6, 2026

(54) MACHINE-LEARNING MATERIAL DATA GENERATION

(71) Applicant: Adobe Inc., San Jose, CA (US)

(72) Inventors: Xiaohe Ma, Zhejiang Province (CN); Yiwei Hu, New Haven, CT (US); Valentin Mathieu Deschaintre, London (GB); Miloš Hašan, Lafayette, CA (US); Fujun Luan, Sunnyvale, CA (US)

(73) Assignee: Adobe Inc., San Jose, CA (US)

(21) Appl. No.: 19/042,081

(22) Filed: Jan. 31, 2025

(51) Int. Cl. G06T 11/00

(52) U.S. Cl. CPC G06T 11/00; G06T 2200/24

(57) ABSTRACT

Techniques for machine-learning material data generation are described. In an example, a processing device is operable to receive a digital image depicting a material and generate a set of video frames depicting physically-based rendering properties of the material. The set of video frames is generated based on the digital image using a video generative machine-learning model. The processing device is operable to output material data based on the physically-based rendering properties of the material depicted by the set of video frames.

### BACKGROUND

3D modeling tools use high-quality material data, such as material images and property maps for physically-based rendering digital content. Conventional 3D modeling tools provide material data generators that automate aspects of material data creation, allowing users to customize material data to align with materials depicted by digital images. Effectiveness of conventional material data generators is limited by various design and implementation considerations. Conventional material data generators struggle to represent materials depicted by digital images that show complex patterns or distorted textures, leading to poor performance and inaccurate results. Additionally, conventional material data generation inhibits utilization of priori of underlying architectures, further limiting robustness and capability for authoring material data.

### SUMMARY

Machine-learning material data generation is described to address conventional technical challenges in generating material data used to render photorealistic digital content, e.g., images and videos. To improve performance and flexibility in producing material data, the described techniques support extraction of physically-based rendering properties of materials inferred from multimodal inputs. A content processing system, for example, uses a machine-learning model to generate material data based on a digital image of a material and text input describing the material. The material data output from the model includes material images (e.g., material maps, a reference image, a mask) usable as inputs to a renderer. Based on the material images, the renderer applies the physically-based rendering properties (e.g., albedo, normal, height, roughness, metallic) to produce a photorealistic texture or surface rendering of that material. The machine-learning model is based on a video generative model, such as a multi-channel diffusion-transformer based video generative model with multiple diffusion-transformer channels. Rather than re-train from scratch or alter the underlying architecture, priori information of the video generative model is preserved to generate a set of high-quality video frames based on image and text inputs. The machine-learning model is finely tuned (e.g., further trained) to generate a specific set of video frames depicting material images used for material data. Each channel (e.g., each diffusion-transformer channel), for instance, is trained to generate a different video frame for depicting a different corresponding material image. As one example, the set of video frames include a reference image based on the input, a mask based on the reference image, and one or more material maps (e.g., albedo map, normal map, height map, roughness map, and metallic map) derived from the reference image and the mask. Care taken to preserve the priori information of the video generative architecture improves robustness and effectiveness when interpreting the multimodal inputs. By generating the material data based on a set of video frames, the machine-learning model efficiently derives accurate material images from partial descriptions, and distorted image views.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques described herein for machine-learning material data generation.

FIG. 2 is a block diagram of a system as an example implementation of a machine-learning model that is operable to employ techniques described herein for machine-learning material data generation.

FIG. 3 is a block diagram of a system as an example implementation of a training module that is operable to train the machine-learning model depicted in FIG. 2.

FIG. 4 is a block diagram of a system as an example implementation of the machine-learning model depicted in FIG. 2.

FIGS. 5a, 5b, and 5c depicts a sequence of screen shots of a user interface of a machine-learning model that is operable to employ techniques described herein for machine-learning material data generation.

FIG. 6 is a flow diagram depicting an algorithm as a step-by-step procedure, which is performable by a processing device to implement techniques described herein for machine-learning material data generation.

FIG. 7 illustrates an example system including various components of an example device usable as any type of computing device as described and/or utilized with reference to FIGS. 1-6 to implement examples of the techniques described herein.

FIG. 8 shows an example of a guided diffusion model according to aspects of the present disclosure.

FIG. 9 shows a diffusion process according to aspects of the present disclosure.

FIG. 10 shows an example of a method for training a diffusion model according to aspects of the present disclosure.

### DETAILED DESCRIPTION

### Overview

Production of realistic digital content is enabled by three-dimensional (3D) modeling tools. Game development, movie and television production, and digital marketing are areas where innovation and creativity are being driven by recent advances in 3D modeling, which is supported by material data generation. Material data, such as material maps, defining physically-based rendering properties is used by 3D modeling tools for texturing surface appearances and rendering photorealistic scenes. Realism of the renderings improves when high-quality material data is used.

Conventional 3D modeling tools implement material data generators that automatically create material data for rendering surface appearances. A conventional material data generator uses machine-learning to automatically produce material data that is usable for physically-based rendering based on user inputs and material depictions by one, ten, or hundreds of digital images. Adopting a generative machine-learning model architecture, such as a Generative Adversarial Network (GAN) based model including a diffusion-transformer based model, improves capability of a conventional material data generator. Various machine-learning design and implementation considerations limit performance and usefulness of conventional material data generators, including conventional material data generators using generative model architectures.

Conventional machine-learning models used as material data generators struggle to represent materials depicted in digital images featuring complex texture patterns or texture distortions, e.g., caused by variable lighting and camera conditions. Conventional material data generator models, including generative model based architectures, expect to receive inputs of digital images that satisfy strict lighting and camera conditions, such as depicting fronto-parallel views of a material illuminated by a camera flash. Using conventional material data generator models to generate material data based on ordinary images, such as digital images depicting non-fronto-parallel views or digital images that do not satisfy expected lighting and camera conditions, leads to poor performance and unrealistic results.

Conventional material data generator models hinder utilization of priori information of an underlying machine-learning architecture. Each material data generator model is based on an existing machine-learning architecture, which is pretrained with priori information to execute specific machine-learning tasks. When an existing diffusion-transformer video generative model is the basis for a conventional material data generator, the priori information of the original architecture enables the conventional material data generator to generate high-quality images and videos in response to a wide range of diverse text and image inputs. Conventional designs and implementations of material data generator models hinder utilization of the priori information. For example, conventional material data generator models are either completely re-trained from scratch, e.g., using synthetic material training data, or the original architecture is significantly modified in various ways by design, either of which causes the priori capability to be lost. Inhibiting utilization of the priori of an underlying architecture of a conventional material data generator limits robustness, performance, and results.

Accordingly, techniques for machine-learning material data generation are described that address conventional technical challenges producing material data used to render photorealistic digital content, e.g., images and videos. To improve performance and flexibility in producing material data, these techniques support physically-based rendering properties being defined based on multimodal inputs. Based on text inputs, digital images, or a combination of text and digital image inputs, material images and maps (e.g., albedo, normal, height, roughness, metallic) are automatically generated. In variations, the multimodal inputs include an image prompt including a digital image depicting a material and a text prompt including a text input describing the material. The text inputs, such as, material descriptors and image embeddings, describe material textures and surfaces. The digital image, which in variations includes an ordinary image captured under a wide variety of camera and lighting conditions, depicts the material textures and surfaces. The digital image inputs are not restricted to fronto-parallel views captured under controlled camera and lighting conditions. Ordinary digital images depicting non-fronto-parallel views captured under seemingly endless possible capture conditions are suitable as the digital image inputs.

In an example, a content processing system is operable to implement the described techniques using a machine-learning model trained to process multimodal inputs received at the content processing system to generate material data for physically-based rendering. When processing a digital image, the machine-learning model generates material data for a primary material depicted in a corresponding segment of the digital image. In at least one implementation, the machine-learning model automatically segments a digital image to isolate one or more primary materials depicted in the digital image, without user intervention. In variations, a user interface is provided to receive user inputs for selecting the corresponding segment depicting the primary material in the digital image or altering dimensions or locations of the corresponding segment to resize or encompass a different region of the digital image.

The content processing system uses the multimodal inputs and, if defined, the corresponding segment, to generate a reference image and a mask for inclusion as a plurality of material images contained in the material data. The reference image is based on the digital image to depict a material subject of the material data in a real-life or simulated scene. In cases where a text input is also received, the reference image is a modified version of the digital image to incorporate alterations inferred from the text input, as one example. The mask differentiates an image region of the reference image, where a primary material is identifiable, from other image regions. Care is taken not to include other materials depicted near the image region boundaries. Initially the mask is aligned with the corresponding segment. Overtime, through machine-learning, the mask is improved to accurately delineate image region boundaries and ensure material maps later produced from the mask are analyzing relevant data.

Recognizing a similarity between generating material data (e.g., a series of material images including a reference image, a mask, and material maps) and a video (e.g., a set of video frames), the machine-learning model of the content processing system is supported by an underlying video generative machine-learning architecture. For example, the machine-learning model of the content processing system is a diffusion-transformer based video generative machine-learning model, including multiple diffusion-transformer channels. The underlying machine-learning architecture utilizes priori capability to generate a series of images as a set of video frames based on image and text inputs. Each diffusion-transformer channel inherits the priori capability of the underlying architecture and is pre-trained to output a set of video frames as a series of images depicting various scenes inferred from text and image prompts.

The material data, which is a series of material images, resembles a video by sharing a similar data composition and structure as a set of video frames output from the machine-learning model. Rather than inhibit utilization of the priori information of the machine-learning model by re-training from scratch or altering the architecture's design, the content processing system fine-tunes, through additional training, the diffusion-transformer video generative machine-learning model to generate a specific type of video with a particular set of video frames, which are usable as material data for rendering. The priori information is maintained to improve robustness and enhance the capability for processing diverse prompts. After training to fine-tune the model's capability, the video generative machine-learning model is especially suited to produce a set of video frames that represent material data used for rendering.

In diffusion-transformer implementations with multiple channels, each diffusion-transformer channel is trained to produce a different video frame for depicting a different material image or material map of the material data. To improve performance and accuracy, a respective diffusion loss associated with each diffusion-transformer channel is individually monitored and compensated relative the reference image and the mask. In one video frame, the video generative machine-learning model outputs the reference image of the material data. In another video frame, the machine-learning model outputs the mask, for instance, generated by a first diffusion-transformer channel that is trained to generate the mask based on the reference image. Second, third, fourth, fifth, and sixth diffusion-transformer channels are trained to generate each of the material maps (e.g., albedo, normal, height, roughness, metallic) for the remaining frames based on the reference image and the mask.

The reference image, the mask, and the material maps are concatenated in the output from the machine-learning model to form a series of material images corresponding to material data based on the set of video frames. The material data is output in a format to be used as input to a physically-based renderer. By treating the material data (e.g., the reference image, the mask, and the material maps) as a series of images that are similar to a set of video frames, the diffusion-transformer based video generative machine-learning model builds upon the priori of the underlying architecture to efficiently produce a specific set of video frames that depict each material image for the material data. Utilizing the priori of the video generative machine-learning model in combination with the additional training (e.g., the model fine-tuning) improves generalization and robustness interpreting the multimodal text and image prompts.

The material data generated based on the multimodal inputs enable the content processing system to automatically output realistic material data based on material descriptions and material depictions derived from unrestricted multimodal inputs. Care taken to preserve prior information of an underlying video generative machine-learning architecture improves effectiveness in correctly interpreting the multimodal inputs. Simple multimodal inputs are usable to generate material data for realistic and efficient rendering, despite brief descriptions and distorted texture and material depictions. Further discussion of these and other examples and advantages are included in the following sections and shown using corresponding figures. Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regressions, logistic regressions, Bayesian networks, random forest learning models, dimensionality reduction algorithms, boosting algorithms, deep learning neural networks, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. For example, generative Al models based on large language models are operable to create new digital content, including text, images, music, videos, and other consumable data. Generative Al models learn patterns and structures from existing data and use this knowledge to generate new, similar, or derivative content. To train a generative Al model or other type of large language model, the underlying machine-learning model is provided with training data that includes examples of text to train and retrain the model to predict a next word in a sequence. Over time, the model, once trained, is configured to generate digital content that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “video generative machine-learning model” refers to a type of machine-learning model specifically designed to create video content by learning from and predicting sequences of frames. Video generative machine-learning models analyze training data, including video sequences, to understand temporal dynamics and spatial features. Examples of video generative machine-learning models include neural networks, recurrent neural networks (RNNs), variational autoencoders (VAEs), and diffusion-transformer based models. Diffusion-transformer based video generative machine-learning models combine strengths of diffusion models, which iteratively refine noisy data to generate high-quality samples, with transformer architectures that capture long-range dependencies and complex patterns in data. Diffusion-transformer based video generative machine-learning models are trained on extensive video datasets to learn the intricate details of motion and scene transitions, enabling diffusion-transformer based video generative machine-learning models to generate coherent and contextually relevant video content based on text and image prompts. By leveraging the capabilities of both diffusion processes and transformer networks, diffusion-transformer based video generative machine-learning models achieve high performance in generating realistic and high-fidelity digital content.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Material Data Generation Environment

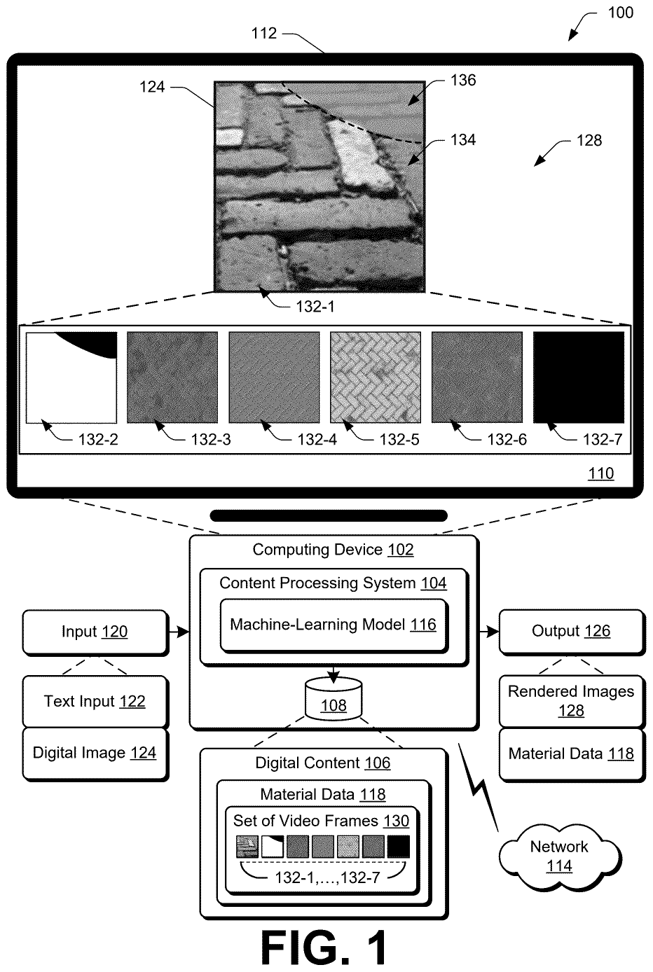

FIG. 1 is an illustration of a digital medium environment 100 in an example implementation that is operable to employ techniques described herein for machine-learning material data generation. The environment 100 includes a computing device 102, which is configurable in a variety of ways.

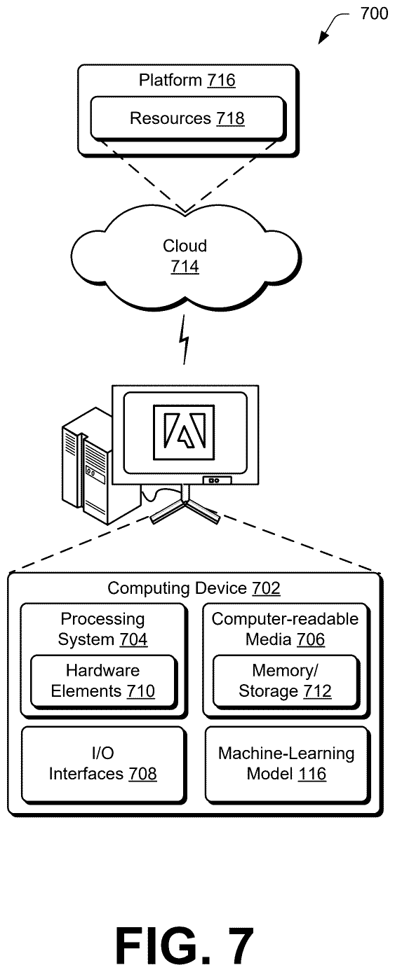

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 7.

The computing device 102 is illustrated as including a content processing system 104. The content processing system 104 is implemented at least partially in hardware of the computing device 102 to process and transform digital content 106, which is illustrated as being maintained in storage 108 of the computing device 102. Such processing includes creation of the digital content 106, modification of the digital content 106, and rendering or re-rendering based on the digital content 106 for presentation in a user interface 110, e.g., for output by a display device 112, for output in other formats (e.g., text based, speech based, video based, sensor based) that are understandable to a user. Although illustrated as implemented locally at the computing device 102, functionality of the content processing system 104 is also configurable in whole or in part through functionality available via a network 114, such as part of a web service or “in the cloud”.

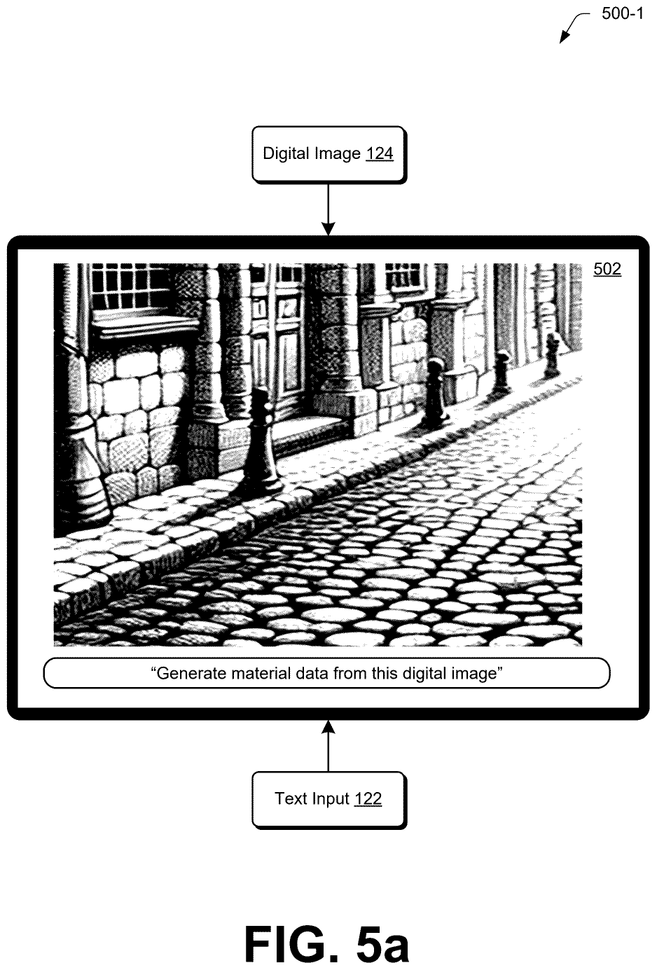

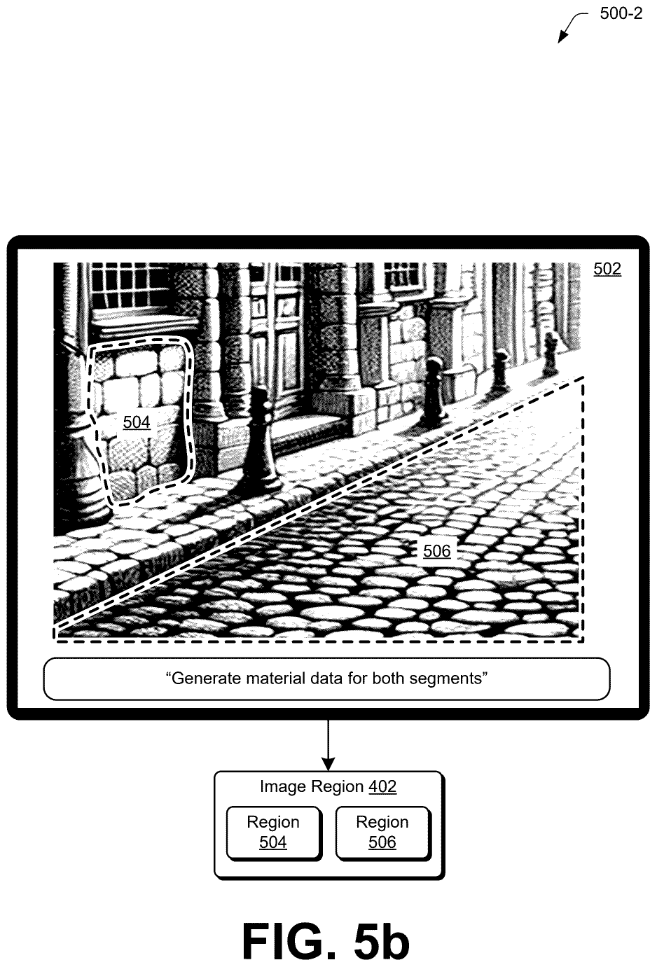

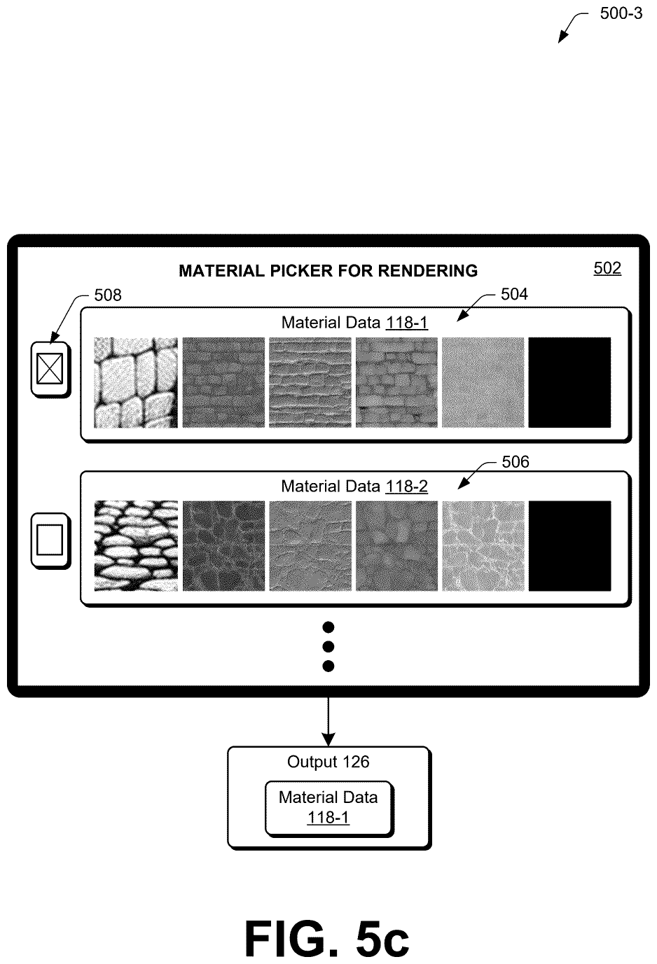

An example of functionality incorporated by the content processing system 104 for processing the digital content 106 is illustrated as a machine-learning model 116. The machine-learning model 116 is configured to implement techniques for using machine-learning to generate material data 118 for use in rendering. The machine-learning model 116 enables the content processing system 104 to create the material data 118, efficiently and effectively, including to generate the material data 118 to be usable by a render to produce realistic rendered images of surface textures and other simulated material appearances defined by physical-rendering properties depicted by the material data 118. The machine-learning model 116, for instance, supports a 3D modeling tool of the content processing system 104, and the user interface 110 supports users' interactions with the tool for creating and selecting different versions of the material data 118, which is used for rending surface textures of simulated 3D objects. A working example of a user interacting with the user interface 110 to use the 3D modeling tool implemented by the machine-learning model 116 is depicted in FIGS. 5a, 5b, and 5c.

The computing device 102 receives an input 120, for instance, from an input device coupled to the computing device 102, such as a sensor, a camera, a microphone, a touch screen, a stylus, or a mouse. The content processing system 104 and the machine-learning model 116 receive the input 120, which is multimodal in the illustrated example, including a text input 122 and a digital image 124. Other input modalities of the input 120 are possible, such as audio inputs or other inputs received from the input devices coupled to the computing device 102. As one example, the content processing system 104 receives the input 120 to support the material data 118 authoring features of the 3D modeling tool. The machine-learning model 116 automatically generates the material data 118 for the 3D modeling tool based on the input 120. In the illustrated example and other examples described below including with reference to the additional drawings, the input 120 received by the machine-learning model 116 includes the text input 122, the digital image 124, or a combination of the text input 122 and the digital image 124.

A material depicted in the digital image 124, for example, is used by the machine-learning model 116 in combination with a material description inferred from the text input 122 to enable the material data 118 editing features of the 3D modeling tool. The digital image 124 depicts a non-fronto-parallel view of a material in at least one example, and the digital image 124 depicts a fronto-parallel view of the material in another example. The material description includes captioning text, for instance, which is automatically or manually applied (e.g., as an image embedding) to the digital image 124 to characterize aspects of the material. In other examples, the text input 122 is user text or natural language prompt describing an alteration to the material depicted in the digital image 124 (e.g., “create a material asset like the material in this image but use a blueish material instead of the reddish hue depicted”, “generate a material asset from the road pavers in this image”). In variations, the input 120 includes the digital image 124 without including the text input 122 and the material data 118 is generated based alone on the material depiction from the digital image 124.

The machine-learning model 116 and the content processing system 104 generate an output 126 of the computing device 102 in response to the input 120. In the illustrated example, the output 126 includes rendered images 128 and the material data 118. A user interacts with the computing device 102 to create the material data 118. Based on the input 120 received by the machine-learning model 116, the user interface 110 displays the rendered images 128 to facilitate user authoring tools for generating the material data 118, such as for modifying, selecting, or evaluating the material data 118 to refine various details.

The material data 118 is output from the content processing system 104 based on a set of video frames 130 previously generated and stored by the machine-learning model 116 among the digital content 106. The set of video frames 130, for example, include a set of material images 132. A reference image 132-1 is based on the input 120 and shows a material depicted in the digital image 124. A mask 132-2 isolates a corresponding segment 134 depicting the material in the digital image 124 or the reference image 132-1 from other regions 136 of the digital image 124 or the reference image 132-1. The mask 132-2 is applied to the digital image 124 or the reference image 132-1 to limit generation of material maps to be based on the corresponding segment 134 of the digital image 124 or the reference image 132-1. One or more of the material images 132 depict two dimensional fronto-parallel material maps depicting the various physically-based rendering properties derived for the material depicted in the reference image 132-1. For example, the material images 132 include one or more of an albedo material map 132-3, a normal material map 132-4, a height material map 132-5, a roughness material map 132-6, and a metallic material map 132-7. The mask 132-2 is applied to the reference image 132-1 to limit each extraction of the physically-based rendering properties from the reference image 132-1 to the corresponding segment 134. Each of the material maps included in the set of video frames 130 corresponds to a different physically-based rendering property of the material data 118.

The rendered images 128 are shown in the user interface 110 to depict the reference image 132-1 generated based on the digital image 124, for example, presenting a copy of the digital image 124, a crop of the digital image 124, or other modification to the digital image 124. If the text input 122 is received with the digital image 124, the machine-learning model 116 further refines the reference image 132-1 based on the text input 122 and conveys the refinement through updates to the rendered images 128. Below the reference image 132-1, the user interface 110 includes the rendered images 128 that preview the rest of the material images 132 generated for the material data 118 being created with the content processing system 104. When satisfied with the material data 118 previewed by the user interface 110, a user input to the computing device 102 cause the material data 118, including the material images 132 based on the set of video frames 130, to be stored as the digital content 106 for use in physically-based rendering other digital content.

In at least one example, the material data 118 is included in the output 126, which is up-loadable through the network 114 to a cloud for sharing or utilizing the material data 118 in other rendering environments. For example, the material data 118 is input to a render executing on a remote device that textures a surface appearance for a rendering based on the physically-based rendering properties defined by the material data 118. In response to detecting a selection of the material data 118 from a material asset selector of a user interface of the remote device, the renderer generates a photorealistic surface appearance based on the material images 132 contained in the material data 118.

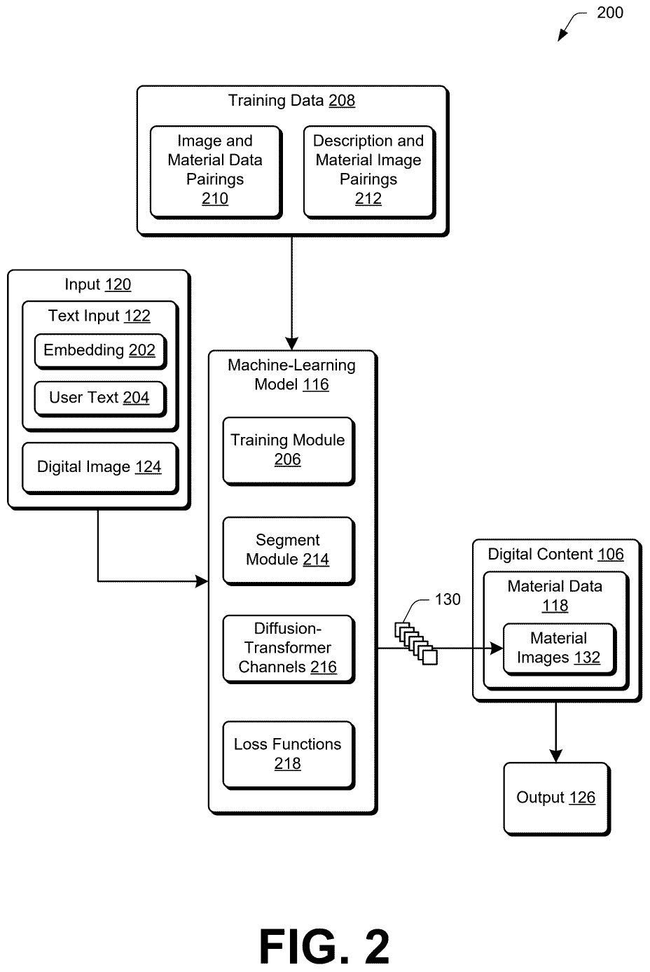

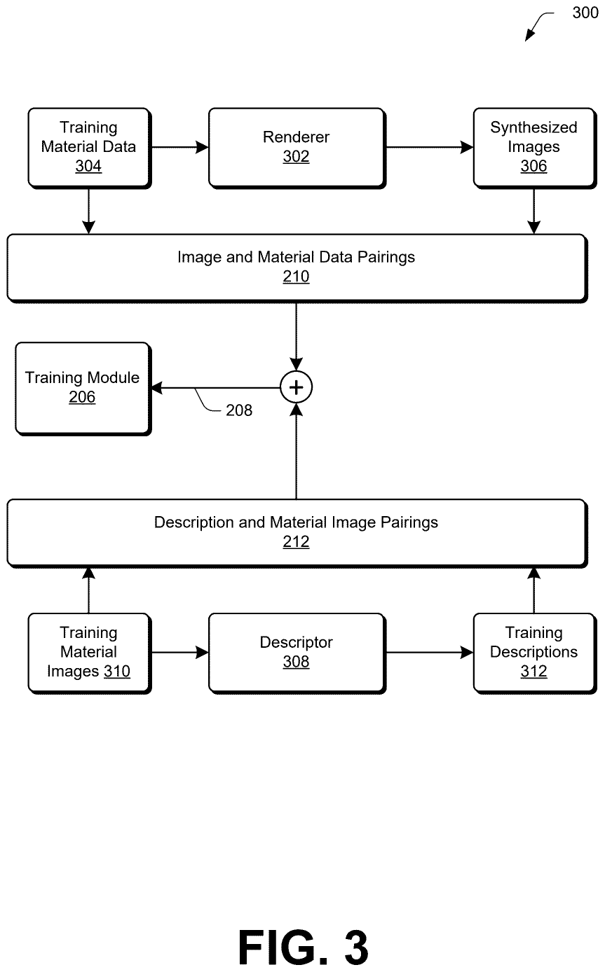

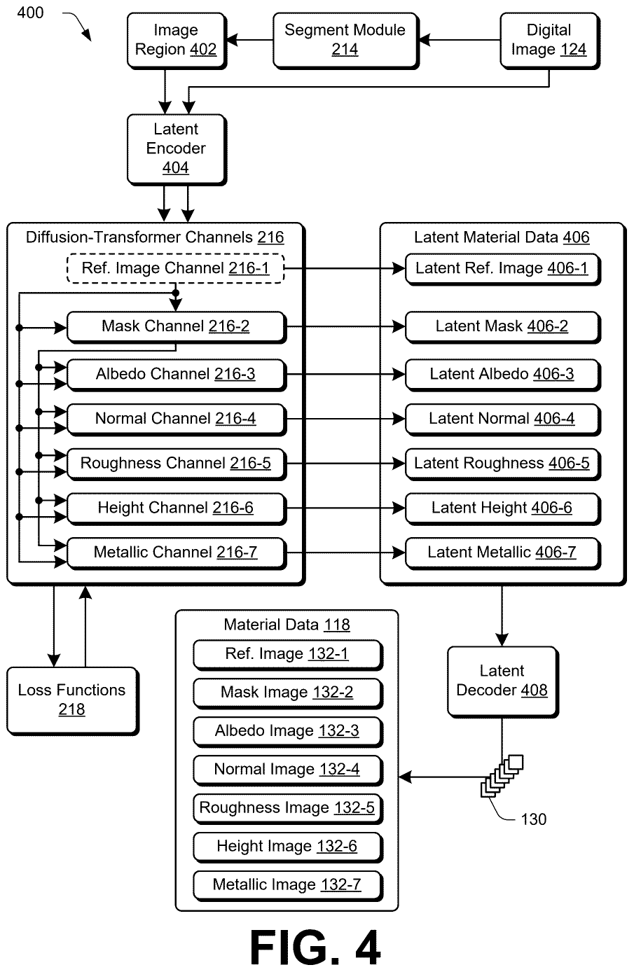

The machine-learning model 116 is configured to create the material data efficiently and effectively 118 to be usable for producing the rendered images 128 or other photorealistic renderings using a video generative machine-learning model. The machine-learning model 116 inherits priori video generative capability of the video generative machine-learning model to create realistic video frames based on text and image prompts. Recognizing the material images 132 to be a series of images similar to video frames, the machine-learning model 116 enhances the priori capability of the video generative architecture based on a training process that configures the machine-learning model 116 to generate a specific type of video, including the set of video frames 130 to capture each of the material images 132 of the material data 118 in a different video frame. The machine-learning model 116 is trained beyond the priori capability of the vide-generation architecture to generate the set of video frames 130 representing the physically-based rendering properties of the material depicted in the digital image 124. Detailed examples of implementing and training the machine-learning model 116 are depicted in FIG. 2, FIG. 3, and FIG. 4.

In response to receiving one or more of the digital image 124 and the text input 122, the machine-learning model 116 automatically generates the set of video frames 130 depicting physically-based rendering properties of the material depicted by the digital image 124 or described by the text input 122. The machine-learning model 116 outputs the material data 118 including the material images 132 based on the physically-based rendering properties depicted by the set of video frames 130.

The material data 118 generated based on the multimodal input 120 enables the content processing system 104 to automatically output realistic material data based on material descriptions and material depictions derived from unrestricted multimodal inputs. Care taken to preserve prior information of an underlying video generative machine-learning architecture of the machine-learning model 116 improves effectiveness in correctly interpreting the multimodal inputs. The input 120 includes simple multimodal inputs, which are usable to generate the material data 118 for realistic and efficient rendering, despite brief descriptions and distorted texture and material depictions.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture for Using Machine-Learning Material Data Generation

The following discussion describes machine-learning material data generation techniques implementable utilizing the previously described systems and devices. Aspects of each of the procedures are implemented in hardware, firmware, software, or a combination thereof. The procedures are shown as a set of blocks that specify operations performed by one or more devices and are not limited to the orders shown for performing the operations by the respective blocks.

FIG. 2 is a block diagram of a system 200 as an example implementation of the machine-learning model 116 depicted in FIG. 1. Generally, the system 200 is operable to output the material data 118 as the digital content 106 included in the output 126. The material data 118 in the output 126 includes the material images 132 generated based on the set of video frames 130 output in response to the input 120, e.g., one or more of the text input 122 and the digital image 124.

In the example illustrated in FIG. 2, the machine-learning model 116 is configured to receive the input 120 including the digital image 124 alone or in combination with the text input 122. For example, the machine-learning model 116 receives the text input 122 describing the material depicted by the digital image 124 to produce the material data 118 in the output 126. The text input 122 includes an embedding 202 included in the digital image 124, such as metadata for an image embedding or captioning text embedded within the digital image 124 or depicted by the digital image 124. In at least one example, the text input 122 includes user text 204 based on a user input to the user interface 110. The machine-learning model 116 receives the user text 204, for example, to facilitate allowing user control over various aspects of the material data 118 that are not apparent from the digital image 124 or the embedding 202.

A training module 206 of the machine-learning model 116 is illustrated in FIG. 2. The training module 206 is executed to further train the machine-learning model 116 beyond a priori video generative capability based on training data 208. For example, the training data 208 includes image and material data pairings 210 and description and material image pairings 212. The image and material data pairings 210, for example, represent a first set of training pairings each including a reference image of a synthesized material applied as a surface texture in a simulated environment and a set of material images depicting each physically-based rendering property of the synthesized material, e.g., material maps. The description and material image pairings 212, for instance, represent a second set of training pairings each including a material image depicting a physically-based rendering property of a different synthesized material and a corresponding material description. When the training data 208 is used as a training input to the machine-learning model 116, the training module 206 causes the machine-learning model 116 to learn to utilize the priori capability for generating specific sets of video frames (e.g., the set of video frames 130) depicting physically-based rendering properties of materials based on image and text inputs.

A segment module 214 of the machine-learning model 116 automatically designates the corresponding segment 134 encompassing a primary material depicted by the digital image 124. In at least one example, the training module 206 uses the training data 208 to train the segment module 214 to automatically segment the digital image 124 into the corresponding segment 134 defining the material depicted by the digital image 124 as a primary material used to construct the reference image 132-1 based on the digital image 124. The content processing system 104 does not rely on user inputs to define the corresponding segment 134, or the mask 132-2. Instead, the machine-learning module 116 uses the segment module 214 to automatically detect and segment the primary material, simplifying the process for creating the material data 118. An initial mask used as the mask 132-2 is generated based on the corresponding segment 134. The mask 132-2 is further refined by the machine-learning model 116 (e.g., using the diffusion-transformer channels 216) to finalize the mask 132-2 for limiting generation of the physically-based rendering properties of the material data 118 to be based on portions of the digital image 124 depicted by the corresponding segment 134.

In at least one example, the training module 206 manages training operations based on the training data 208 to configure a plurality of channels of the machine-learning model 116 to produce the set of video frames 130 depicting the material images 132. In the illustrated example, the machine-learning model 116 depicted in FIG. 2 uses a diffusion-transformer based video generative model including a plurality of diffusion-transformer channels 216. The training module 206 performs training operations based on the training data 208 to configure each of the different diffusion-transformer channels 216 to produce a different video frame in the set of video frames 130.

The diffusion-transformer channels 216 are individual generative diffusion models that iteratively transform an initial noise distribution (e.g., Gaussian noise) into a complex real-world data distribution, e.g., images or image encodings. The diffusion process relies on a forward process that progressively transforms the original data distribution into a noise distribution. For example, this is achieved by iteratively adding Gaussian noise to the data sample. Given data samples x~p_{data}, corrupted data

$$p ( {x}_{T} \vert {x}_{0} ) = {\prod }_{t = 1}^{T} p ( {x}_{t} \vert {x}_{t - 1} , ϵ ) , ϵ ∼ N ( 0 , I )$$

are constructed in T diffusion steps. To sample the original data distribution p_{data} from the noise distribution, a reverse mapping

$$p ( {x}_{0} ) = p ( {x}_{T} ) {\prod }_{t = 1}^{T} p ( {x}_{t} \vert {x}_{t - 1} , {ϵ}_{t} )$$

is modeled where Et is the noise predicted at each step by the machine-learning model 116, modeled as neural network f_{θ}. The machine-learning model 116/neural network f_{θ} is conditioned on the denoising step t to predict the noise Et, which is then used to reconstruct xₜ₋₁ from xₜ in each reverse step based on Equation (1):

$${E}_{x ∼ {p}_{d ata} , t \sim U ( 0 , 1 ) [ {‖ {ϵ}_{t} - {f}_{θ} ( {x}_{t} , c , t ) ‖}^{2} ]}$$

In Equation (1), c represents conditional inputs, e.g., text prompts or images. The diffusion-transformer channels 216 support a backbone of the machine-learning model 116, to model the neural network f_{θ}. The visual data x∈ [symbol] ^{T×3×H×W} is tokenized patch-wise, resulting in visual tokens \hat{x}∈ [symbol] ^{V×D} where H, W, T are the spatial and temporal dimensions of the video, V is the number of tokens and D is the feature dimension. Positional encoding is also added to \hat{x} to specify spatial and temporal order. Each possible condition c is also embedded as tokens ĉ∈ [symbol] ^{V′×D} where V′ is the number of the tokens for conditional inputs. For example, when c is text, c is encoded by a pre-trained encoder with additional embedding layers to map c into the same feature dimension D. The transformer f_{θ}(\hat{x}ₜ,ĉ,t) is trained to denoise each patch at timestep t. The final denoised patches \hat{x}₀∈ [symbol] ^{V×D} are reassembled as visual data x₀∈ [symbol] ^{T×3×H×W} after decoding through linear layers. Because the number of tokens grows quickly with resolution, a variational autoencoder (VAE) model is usable before the tokenizing process, producing a latent representation of y∈ [symbol] ^{T′×D′×H′×W′} of the original data x for the transformer to process.

In the illustrated example, the diffusion-transformer channels 216 of the machine-learning model 116 are configured using a plurality of layers including, respectively, a plurality of nodes. The plurality of layers are configurable to include an input layer, an output layer, and one or more hidden layers. Calculations are performed by the nodes within the layers via hidden states through a system of weighted connections that are “learned” during training and retraining of the diffusion-transformer channels 216 to implement a variety of tasks, including generating individual video frames of the set of video frames 130.

To train the diffusion-transformer channels 216 of the machine-learning model 116, the training module 206 receives the training data 208 to obtain examples of “what is to be learned” by each of the diffusion-transformer channels 216, i.e., as a basis to learn patterns from the training data, and include input features and corresponding target labels, i.e., of what is exhibited by the input features. The training module 206 initializes parameters of the diffusion-transformer channels 216, which are used as internal variables to represent and process information during training and represent inferences gained through training. In an implementation, the training data 208 for the training module 206 is separated into batches to improve processing and optimization efficiency of the parameters during training.

A portion of the training data 208 is then received as an input by each of the diffusion-transformer channels 216. Each portion of the training data 208 is used as a basis for generating predictions based on a current state of parameters of layers and corresponding nodes, a result of which is output as output data. Output data describes an outcome of the task, e.g., as a probability of being a member of a particular class in a classification scenario.

Training of the machine-learning module 116, the segment module 214, and each of the diffusion-transformer channels 216 described herein includes calculating loss functions 218 to quantify a loss associated with operations performed by each of the diffusion-transformer channels 216. For example, the loss functions 218 are configured to calculate the respective loss function for each of the diffusion-transformer channels 216, for instance, by implementing functions for comparing a difference between predictions specified in the output data from each of the diffusion-transformer channels 216 with target labels specified by the training data 208. In one or more aspects, the loss functions output iterative loss data based on analysis of the material images 132 output from the diffusion-transformer channels 216 to portions of the reference image 132-1 captured by the mask 132-2 to cause consistency between how the diffusion-transformer channels 216 depict the physically-based rendering properties in the set of video frames 130. The loss functions 218 are configurable in a variety of ways, examples of which include regret, Quadratic loss function as part of a least squares technique, and so forth.

Calculations of the loss functions 218 also include using a backpropagation operation, for example, as part of minimizing the loss functions 218 and thereby training parameters of each of the diffusion-transformer channels 216 used by the machine-learning model 116. Based on iterative loss data, the machine-learning model 116 is operable to minimize the loss functions 218, for instance, by adjusting weights of the nodes to minimize the loss and thereby optimize performance of each of the diffusion-transformer channels 216 in performance of respective tasks. The adjustment is determined by computing a gradient of the loss functions 218, which indicates a direction to be used to adjust the parameters to minimize the loss. The parameters of each of the diffusion-transformer channels 216 are then updated based on the computed gradient.

In an example, this process continues over a plurality of iterations until each of the diffusion-transformer channels 216 determines that a stopping criterion is met. The stopping criterion employed by the diffusion-transformer channels 216 of the machine-learning model 116 in this example is selected to reduce computational resource consumption, and/or promote an ability of the machine-learning model 116 to address previously unseen data, i.e., information that is not actually included as an example in the training data 208. Examples of a stopping criterion include but are not limited to a predefined number of epochs, validation loss stabilization, achievement of a performance improvement threshold, or based on performance metrics such as precision and recall. As one example, the stopping criterion of the machine-learning model 116 is based on achieving the material images 132 based on the reference image 132-1 and the mask 132-2.

FIG. 3 is a block diagram 300 of a system as an example implementation of the training module 206 depicted in FIG. 2. The training module 206 receives the image and material data pairings 210 (e.g., a scene dataset) and the description and material image pairings 212 (e.g., material dataset) as dataset inputs of the training data 208. The training data 208 is used to train the segment module 214 and each of the diffusion-transformer channels 216. When the datasets of the training data 208 are combined, the training module 206 is configured to jointly train the diffusion-transformer channels for both surface rectification and high quality material generation. The training module 206 is configured to receive additional training sets in other examples to capture a greater diversity of materials and textures.

In the illustrated example, the training module 206 trains the diffusion-transformer channels 216 based on the training data 208 to generate the sets of video frames 130 depicting physically-based rendering properties of materials depicted in digital images and described by text input. For example, the diffusion-transformer channels 216 are each trained to generate one of the video frames in the set of video frames 130 based on the training data 208. The training module 206 further trains the segment module 214 of the machine-learning module 116 based on the training data 208. The segment module 214 learns from the training data 208 to generate the corresponding segment 134 of the digital image 124 used to initialize the mask 132-2 from the reference image 132-1.

The illustrated example in FIG. 3 includes a renderer 302 (e.g., a rendering engine) configured to process training material data 304 into synthesized images 306. For example, the renderer 302 is configured to generate the synthesized images 306 using thousands of seemingly-random 3D models and material data samples included in the training material data 304 accessed by the renderer 302. The synthesized images 306 represent tens or hundreds of seemingly-random examples of rendered images generated by the renderer 302 using the training material data 304. Each of the synthesized images 306 depicts at least one object or surface rendered using one sample of the training material data 304 with seemingly-random camera perspective and lighting conditions. Various light sources, including point lights and area lights, are applied by the renderer 302 to simulate complex real-world illumination. The renderer 302 uses various camera viewpoints to capture a wide variety of texture views to maximize coverage. Each pairing from the image and material data pairings 210 includes one of the synthesized images 306 and a corresponding sample of the training material data 304 used to render that synthesized image. A quality review check is performed by the renderer 302 to ensure that each of the synthesized images 306 depicts a corresponding material represented by a paired sample of the training material data 304 as a primary material. For example, the synthesized images 306 are cropped to cause the corresponding primary material to occupy a majority (e.g., sixty percent) of the total image area.

A descriptor 308 (e.g., an image-to-text generator) is depicted in FIG. 3, which is configured to process training material images 310 into training descriptions 312. For example, the descriptor 308 is configured to generate the training descriptions 312 including text that describes the primary materials depicted in each of the synthesized images 306, and each of the materials represented by the various material images included in the training material data 304. Each pairing from the description and material image pairings 212 includes one of the training material images 310, which includes one of the synthesized images 306 or one of the material images from the training material data 304, in addition to a corresponding material description included in the training descriptions 312.

In at least one example, the training module 206 enhances generalization of the diffusion-transformer channels 216 using the training descriptions 312 and the training material images 310 to further train a text-to-video frame capability. The diffusion-transformer channels 216 improve at interpreting the text input 122 to generate the set of video frames 130, effectively and efficiently.

As previously mentioned, in addition to training the diffusion-transformer channels 216, the training module 206 uses the training data 208 to train the segment module 214. The segment module 214 is trained based on the training data 208 to generate corresponding segments of primary materials depicted by digital images. A user-provided crop of the digital image 124 to depict a single material typically includes multiple materials. Performing conservative cropping on the digital image 124 reduces usable pixels and using an additional segmentation mask involves additional user input or a separate segmentation model. Instead, the segment module 214 is a specially-trained portion of the machine-learning model 116 that automatically identifies primary materials depicted in digital images. A mask V is inferred by the segment module 214 to initialize the mask 132-2.

The training data 208 to the segment module 214, x, is equal to stack (I,V,M), where x E [symbol] ^{7×3×H×W} The set of video frames 130 includes seven video frames, for example, including one of the synthesized images 306, and a mask and five material maps from the training material data 304 used to render that synthesized image. Noise ϵₜ is applied to one or more of the video frames from the set of video frames 130 (e.g., the last six frames) occupied by V and M, resulting in xₜ=stack(I,Vₜ,Mₜ), with the first frame (e.g., the reference image 132-1 based on the synthesized image) remaining free of noise. The objective based on Equation 1 is shown as Equation (2):

$${E}_{x ∼ {p}_{data} , t \sim U ( 0 , 1 ) [ {‖ {ϵ}_{t} - {f}_{θ} ( {x}_{t} , c , t ) [ - 6 : ] ‖}^{2} ]} \qquad Equation ( 2 )$$

In Equation (2), c denotes the training descriptions 312 or material description embedded with that sample of the training material data 304. The notation [−6:] refers to the last 6 frames generated by the diffusion-transformer channels 216. When the input consists solely of c without I, x=stack(V,M) where V is a uniformly white RGB image, the computation of the loss remains unchanged.

FIG. 4 is a block diagram 400 of a system as an example implementation of the machine-learning model 116. For brevity and ease of description, the example shown in FIG. 4 uses the diffusion-transformer channels 216 to generate the material data 118 without using the text input 122. In at least one variation, the text input 122 and the digital image 124 are used in combination by the diffusion-transformer channels 216 to generate the material data 118.

The segment module 214 identifies an image region 402 depicting a material by the digital image 124. A latent encoder 404 of the machine-learning model 116 transforms an indication of the image region 402 (e.g., an initial mask) and the digital image (e.g., a reference image) into latent space of the machine-learning model 116. The output from the latent encoder 404 feeds the input to the diffusion-transformer channels 216, which output latent material data 406.

The diffusion-transformer channels 216 represent a plurality of material property diffusion-transformer channels of the machine-learning model 116, which are each trained to generate the material images 132 depicting different physically-based rendering properties of a renderable material. The diffusion-transformer channels 216 optionally include a reference image channel 216-1 configured to produce a latent reference image 406-1 based on a latent representation of the digital image 124. A mask channel 216-2 of the diffusion-transformer channels 216 is configured to produce a latent mask 406-2 based on the latent reference image 406-1 and the image region 402. An albedo channel 216-3, a normal channel 216-4, a roughness channel 216-5, a height channel 216-6, and a metallic channel 216-7, are each configured to produce a different latent material map included in the latent material data 406. For example, a latent albedo material map 406-3, a latent normal material map 406-4, a latent roughness material map 406-5, a latent height material map 406-6, and a latent metallic material map 406-7 are generated by the diffusion-transformer channels 216. The latent material data 406 concatenates the latent reference image 406-1, the latent mask 406-2, and each of the material maps to assist with denoising.

Excluding the reference image channel 216-1, the loss functions 218 compute a corresponding diffusion-transformer loss associated with each of diffusion-transformer channels 216. The loss functions 218 are calculated for the latent mask 406-2 and each of the material maps. The latent reference image 406-1 is kept consistent throughout the generative material data process and the loss functions 218 do not monitor the latent reference image 406-1. For example, during inference, after each denoising step, the latent reference image 406-1 is reinitialized based on the latent representation of the digital image 124.

A latent decoder 408 transforms the latent material data 406 into the set of video frames 130. The material data 118 generated based on the set of video frames 130 is output from the machine-learning model 116. For example, the reference image 132-1 is decoded from the latent reference image 406-1, the mask 132-2 is decoded from the latent mask 406-2, the albedo material map 132-3 is decoded from the latent albedo material map 406-3, the normal material map 132-4 is decoded from the latent normal material map 406-4, the roughness material map 132-5 is decoded from the latent roughness material map 406-5, the height material map 132-6 is decoded from the latent height material map 406-6, and the metallic material map 132-7 is decoded from the latent metallic material map 406-7.

To utilized the learned priori knowledge of the machine-learning model, the material maps M (e.g., albedo map, normal map, height map, roughness map, and metallic map) are stacked into a set of five video frames, and the temporal positional embedding is computed assuming each has a respective time stamp interval of one second, e.g., one frame per second. Because the diffusion-transformer based video generative architecture of the machine-learning model 116 allows flexibly and generates tokenized data, as opposed to a U-net architecture, the number of frames the machine-learning model 116 is able to produce is not fixed. The original video generative architecture (e.g., the diffusion-transformer channels 216) enables the machine-learning model 116 to generate one or more video frames to represent different quantities of material images. In addition, by utilizing a video generative architecture as opposed to an image generative architecture, the machine-learning model 116 include more than three channels (e.g., red, green, blue) that limit conventional image diffusion-transformer models.

To enable material generation from an image input, the input image I (e.g., the digital image 124) is used as the first frame in the set of video frames 130, with the machine-learning model 116 generating the mask 132-2 and the stacked material maps M as the subsequent frames, similar to a video extension model. The diffusion-transformer channels 216 are operable to ensure that each of the latent material images included in the latent material data 406 are aligned with each other, and the diffusion-transformer channels 216 allow for non-aligned pixels between the input image I and the generated material maps M. The machine-learning model 116 learns to produce the set of video frames 130 without having to align the reference image 132-1, e.g., the input image I. For texture rectification, which is challenging for convolution-based architectures, producing the set of video frames 130 without having to align the reference image 132-1 is part of the priori capability of the video generative architecture due to convolution inductive bias.

FIGS. 5a, 5b, and 5c depict a sequence of screen shots 500-1, 500-2, and 500-3, respectively, of a user interface 502 of the machine-learning model 116. For example, screen shots 500-1, 500-2, and 500-3 are examples screen shots of the user interface 502, which is an example of the user interface 110 displayed by the computing device 102 as a user interacts with the 3D modeling tool implemented by the machine-learning model 116 through the content processing system 104.

In the illustrated example, the 3D modeling tool implemented by the user interface 110 allows a user of the machine-learning model 116 to create the material data 118. Picture a situation where the user is a game developer interacting with the user interface 502 to design a background environment where cobblestone pavers are on the ground.

As depicted in the screen shot 500-1, the user interface 502 displays the digital image 124 as the user interface 110 also receives the text input 122. The digital image 124 depicts several materials in an alley environment of an old city. The text input 122 includes a user input requesting that the machine-learning model 116 “Generate material data from this digital image.”

Next, as depicted in the screen shot 500-2, the segment module 214 of the machine-learning model 116 identifies an image region 504 depicting a first material (e.g., a stone wall) and an image region 506 depicting a second material, e.g., a stone road. In examples, the image region 504 or the image region 506 is automatically selected. In the illustrated example, the user provides an additional text input “Generate material data for both segments” to cause the machine-learning model 116 to generate the material data 118 for both materials, e.g., one set of the material data 118 for the stone wall, and another set of the material data 118 for the stone road. The image region 402 indicative of the image region 504 and the image region 506 is output from the segment module 214 to generate respective masks and material maps using the diffusion-transformer channels 216.

Lastly, the screen shot 500-3 depicts the user interface 502 as a material data selector of the user interface 110, allowing the user to choose the material data 118 for rendering a simulated object. The image region 504 depicting the stone wall is presented as material data 118-1 and the image region 506 depicting the stone road is presented as material data 118-2. In response to detecting a selection 508 of the material data 118-1 from the material data selector of the user interface 502, the material data 118-1 is included in the output 126 for a render (e.g., executing at the content processing system 104 or executing on the network 114) that textures a surface appearance based on the physically-based rendering properties of the material data 118-1.

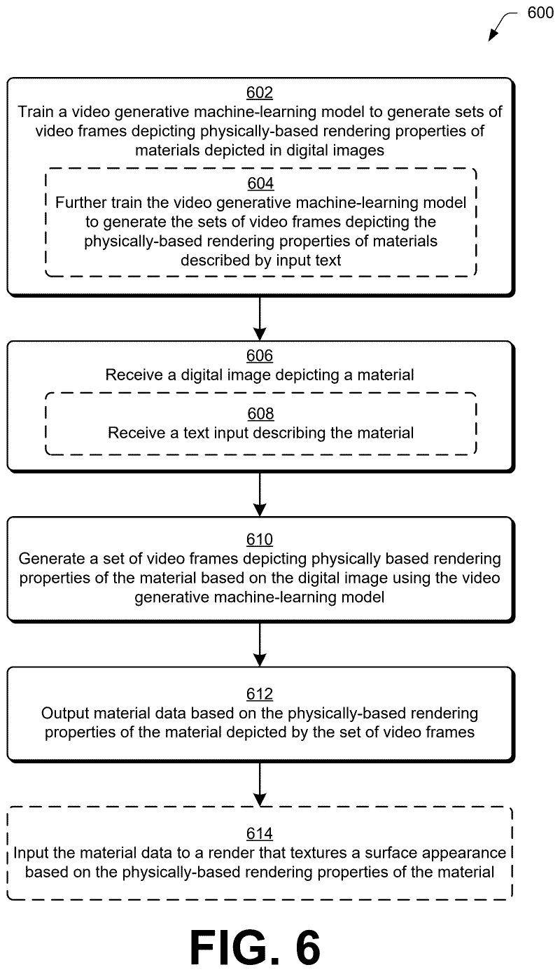

FIG. 6 is a flow diagram depicting an algorithm as a step-by-step procedure 600, which is performable by a processing device to implement techniques described herein for machine-learning material data generation. The procedure 600 is executed by the content processing system 104 using the machine-learning model 116, for instance, to produce the material data 118.

At the start of the procedure 600, a video generative machine-learning model to generate sets of video frames depicting physically-based rendering properties of materials depicted in digital images and described by input text of the materials is trained (block 602). Optionally in the procedure 600, the video generative machine-learning model is further trained to generate the sets of video frames described by input text of the materials (block 604). For example, the machine-learning model 116 is trained by the training module 206 based on the training data 208, including based on the image and material data pairings 210 and the description and material image pairings 212.

The procedure 600 continues by receiving a digital image depicting a material (block 606). In one or more aspects, the machine-learning model 116, once trained, receives the input 120 including the digital image 124.

Optionally in the procedure 600, a text input describing the material is received (block 608). For example, the input 120 includes the text input 122, which is further received by the machine-learning model 116.

The procedure 600 further includes generating a set of video frames depicting physically-based rendering properties of the material based on the digital image using the video generative machine-learning model (block 610). In one or more aspects, the set of video frames 130 (e.g., generated by the diffusion-transformer channels 216) are produced to depict the material images 132.

Next in the procedure 600, material data based on the physically-based rendering properties of the material depicted by the set of video frames is output (block 612). In at least one example, the machine-learning model 116 outputs the material data 118 for future rendering. The material data 118 including the material images 132 based on the set of video frames 130 is stored, for instance, as the digital content 106.

Optionally, the procedure 600 concludes by inputting the material data to a renderer that textures a surface appearance based on the physically-based rendering properties of the material (block 614). In variations, the machine-learning model 116 outputs the material data 118 to a renderer executing at the content processing system 104 to produce the rendered images 128, or through the network 114 to a renderer executing on a remote device, e.g., a cloud-based rendering service.

### Example System and Device

FIG. 7 illustrates an example system 700 including various components of an example device usable as any type of computing device as described and/or utilized with reference to FIGS. 1-6 to implement examples of the techniques described herein. FIG. 7 illustrates an example system 700 generally, which includes an example computing device 702 that is representative of one or more computing systems and/or devices that implement the various techniques described herein. This is illustrated through inclusion of the machine-learning model 116. The computing device 702 is configurable, for instance, as a server of a service provider, as a device associated with a client (e.g., a client device), as an on-chip system, and/or as any other suitable computing device or computing system.

The example computing device 702 as illustrated includes a processing system 704, one or more computer-readable media 706, and one or more I/O interface 708 that are communicatively coupled, one to another. Although not shown, the computing device 702 further includes a system bus or other data and command transfer system that couples the various components, one to another. In one or more examples, a system bus includes a single bus structure, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including the hardware elements 710, which are configurable as processors, functional blocks, and so forth. This includes implementation in hardware as an application specific integrated circuit or other logic device formed using one or more semiconductors. The hardware elements 710 are not limited by the materials that form the hardware elements 710, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 706 is storage media illustrated as including memory/storage 712. The memory/storage 712 represents memory/storage capacity associated with one or more computer-readable media. The memory/storage 712 is configured as a memory component, for example, which is configured to store the digital content 106 and/or the material data 118. The memory/storage 712 includes volatile media (such as random access memory (RAM)) and/or nonvolatile media, such as read-only memory (ROM), Flash memory, optical disks, magnetic disks, and so forth. The memory/storage 712 includes fixed media (e.g., RAM, ROM, a fixed hard drive, and so on) as well as removable media, e.g., Flash memory, a removable hard drive, an optical disc, and so forth. The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 710 include a processing device coupled to the memory component implemented by the memory/storage 712 to perform operations of the machine-learning model 116. The operations, when executed, cause the processing device implemented by the hardware elements 710 to generate the material data 118 to be stored in the memory/storage 712, including for texturing a surface of a simulated object based on the material images 132.

Combinations of the foregoing are also employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (e.g., at least one computing device 702 and/or processing systems 704) to implement techniques, modules, and examples described herein.

The techniques described herein are supported by various configurations of the computing device 702 and are not limited to the specific examples of the techniques described herein. This functionality is also implementable or partially implementable through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data utilized while computer processing is executed on servers that are remote from the computing device 702. In at least one example, the resources 718 include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device example, implementation of functionality described herein is distributable throughout the system 700. The functionality is implementable in part on the computing device 702 as well as via the platform 716 that abstracts the functionality of the cloud 714.

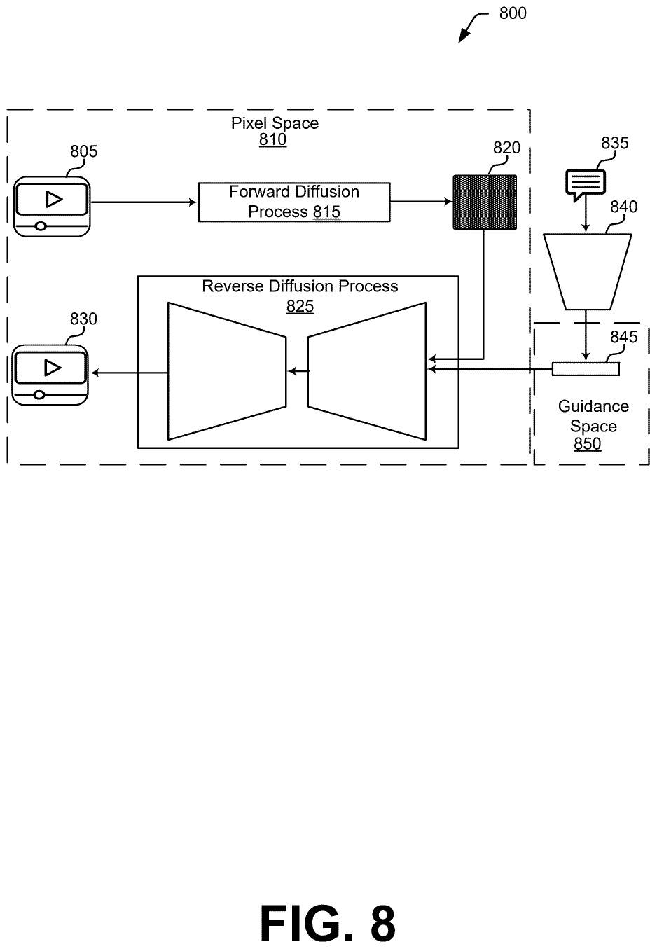

FIG. 8 shows an example of a guided diffusion model 800 according to aspects of the present disclosure. In some examples, the guided diffusion model 800 describes the operation and architecture of the machine-learning model 116. The guided latent diffusion model 800 depicted in FIG. 8 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 800 may take an original media item 805 in a pixel space 810 as input and apply forward diffusion process 815 to gradually add noise to the original media item 805 to obtain noisy media item 820 at various noise levels.

Next, a reverse diffusion process 825 (e.g., a U-Net) gradually removes the noise from the noisy media item 820 at the various noise levels to obtain an output media item 830. In some cases, an output media item 830 is created from each of the various noise levels. The output media item 830 can be compared to the original media item 805 to train the reverse diffusion process 825.

The reverse diffusion process 825 can also be guided based on a text prompt 835, or another guidance prompt, such as an image, a layout, a segmentation map, etc. The text prompt 835 can be encoded using a text encoder 840 (e.g., a multimodal encoder) to obtain guidance features 845 in guidance space 850. The guidance features 845 can be combined with the noisy media item 820 at one or more layers of the reverse diffusion process 825 to ensure that the output media item 830 includes content described by the text prompt 835. For example, guidance features 845 can be combined with the noisy features using a cross-attention block within the reverse diffusion process 825.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

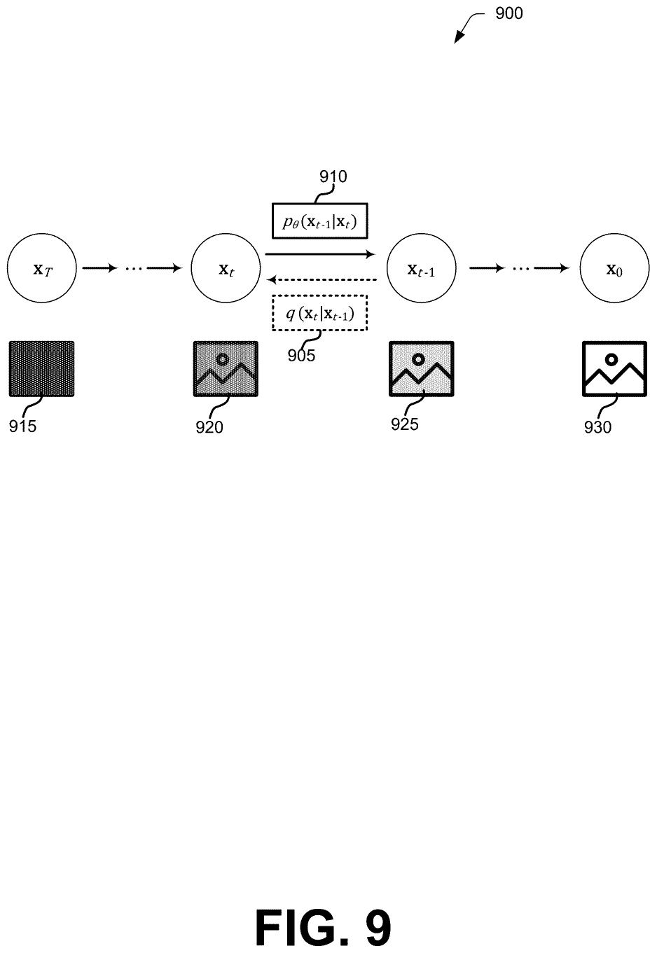

FIG. 9 shows a diffusion process 900 according to aspects of the present disclosure. In some examples, diffusion process 900 describes an operation of the machine-learning model 116, such as the reverse diffusion process 825 of the guided diffusion model 800.

As described above, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x_{T} reverts back to x₀, the original media item 930. The reverse process can be represented as Equation (3):

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad Equation ( 3 )$$

The joint probability of a sequence of samples in the Markov chain can be written as a product of conditionals and the marginal probability from Equation (4):

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad Equation ( 4 )$$

In the Equation (4), p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

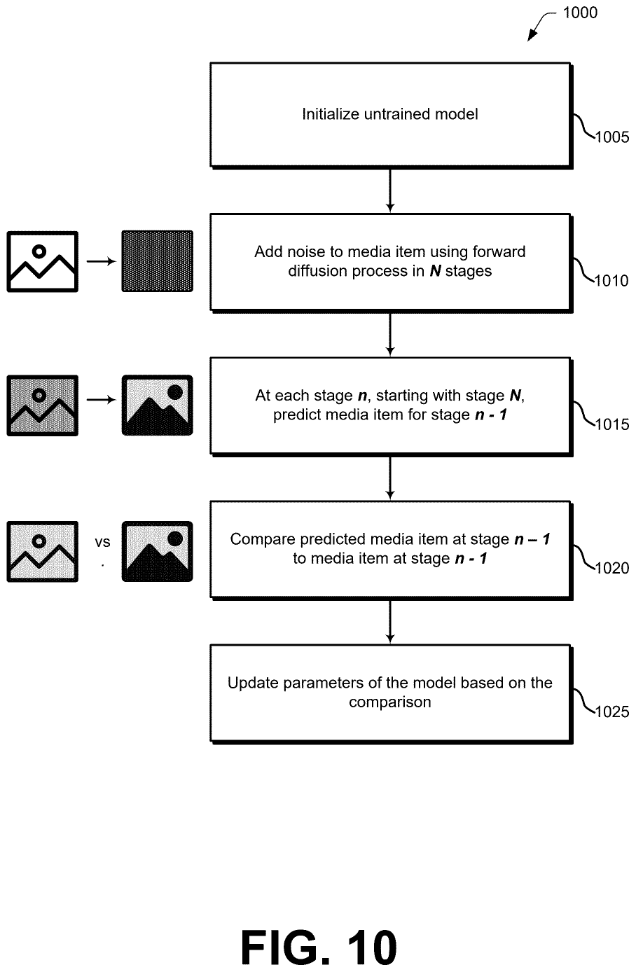

FIG. 10 shows an example of a method 1000 for training a diffusion model according to aspects of the present disclosure. In some embodiments, the method 1000 describes an operation of the training module 206 described for configuring the machine-learning model 116. The method 1000 represents an example for training a reverse diffusion process as described above. In some examples, these operations are performed by a system including a processor executing a set of codes to control functional elements of an apparatus, such as the guided diffusion model 800.

Additionally or alternatively, certain processes of method 1000 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method comprising:
receiving, by a processing device, a digital image depicting a material;
generating, by the processing device, a set of video frames depicting physically-based rendering properties of the material, the generating performed using a video generative machine-learning model based on the digital image; and
outputting, by the processing device, material data based on the physically-based rendering properties of the material depicted by the set of video frames.

2. The method of claim 1, further comprising:
receiving text input describing the material, the generating performed using the video generative machine-learning model based on the digital image and the text input.

3. The method of claim 2, wherein the text input includes one or more of user input at a user interface to the video generative machine-learning model, an image embedding of the digital image, and captioning text of the digital image.

4. The method of claim 1, wherein the material data includes material maps depicted by one or more video frames from the set of video frames, each of the material maps corresponding to a different physically-based rendering property of the material.

5. The method of claim 4, wherein the set of video frames include one or more of a first video frame depicting an albedo material map, a second video frame depicting a normal material map, a third video frame depicting a height material map, a fourth video frame depicting a roughness material map, and a fifth video frame depicting a metallic material map.

6. The method of claim 4, wherein the material data includes a mask depicted by a video frame from the set of video frames that is applied to a reference image to limit generation of the material maps to be based on a corresponding segment of the reference image.

7. The method of claim 4, wherein the material data includes a reference image in a video frame from the set of video frames based on the digital image.

8. The method of claim 7, wherein the digital image depicts a non-fronto-parallel view of the material.

9. The method of claim 1, further comprising:
training the video generative machine-learning model to generate sets of video frames depicting physically-based rendering properties of materials depicted in digital images and described by text input.

10. The method of claim 1, wherein the outputting includes inputting the material data to a render that textures a surface appearance based on the physically-based rendering properties of the material in response to detecting a selection of the material data from a material data selector of a user interface.

11. A system comprising:
a memory component; and
a processing device coupled to the memory component that cause a video generative machine-learning model to perform operations including:
generating a set of video frames that depict physically-based rendering properties of a material depicted in a digital image; and
outputting material data based on the physically-based rendering properties of the material as depicted by the set of video frames.

12. The system of claim 11, wherein the video generative machine-learning model generates the set of video frames based on the digital image and a text input describing the material.

13. The system of claim 11, wherein the operations further included:
automatically segmenting the digital image into a corresponding segment defining the material as a primary material depicted in a reference image based on the digital image.

14. The system of claim 13, wherein a video frame from the set of video frames depicts a mask applied to the reference image to limit generation of the physically-based rendering properties of the material based on the corresponding segment.

15. The system of claim 14, wherein the set of video frames include one or more of a first video frame depicting an albedo material map, a second video frame depicting a normal material map, a third video frame depicting a height material map, a fourth video frame depicting a roughness material map, and a fifth video frame depicting a metallic material map.

16. The system of claim 15, wherein the video generative machine-learning model includes a diffusion-transformer based video generative model having a plurality of material property diffusion-transformer channels each trained to generate a material map depicting a different physically-based rendering property of the material based on the reference image and the mask, and a mask diffusion-transformer channel trained to generate the mask based on the reference image.

17. The system of claim 16, wherein the diffusion-transformer based video generative model applies a corresponding diffusion-transformer loss associated with each of the plurality of material property diffusion-transformer channels and the mask diffusion-transformer channel.

18. A non-transitory computer readable storage medium comprising instructions that, when executed, configure at least one processing device to perform operations including:
training a video generative machine-learning model to generate sets of video frames depicting physically-based rendering properties of materials depicted in digital images and described by input text of the materials;
executing the video generative machine-learning model to generate, based on a digital image depicting a material and a text input describing the material, a set of video frames depicting physically-based rendering properties of the material; and
outputting material data based on the physically-based rendering properties of the material as depicted by the set of video frames.

19. The non-transitory computer readable storage medium of claim 18, wherein the video generative machine-learning model is trained based on a first set of training pairings each including a reference image of a synthesized material applied as a surface texture in a simulated environment and a set of material images depicting each physically-based rendering property of the synthesized material.

20. The non-transitory computer readable storage medium of claim 19, wherein the video generative machine-learning model is further trained based on a second set of training pairings each including a material image depicting a physically-based rendering property of a different synthesized material and a corresponding material description.
